(19) United States
(12) Patent Application Publication
(10) Pub. No.: US 2018/0283279 A1
(43) Pub. Date: Oct. 4, 2018

(54) METHOD FOR REMOVING COMBUSTOR COMPONENTS FROM AN ASSEMBLED TURBINE ENGINE

(71) Applicant: SIEMENS ENERGY, INC., ORLANDO, FL (US)

(72) Inventors: CLIFFORD HATCHER, JR., ORLANDO, FL (US); JAMES P. WILLIAMS, ORLANDO, FL (US); DOMINICK CALABRIA, ORLANDO, FL (US)

(21) Appl. No.: 15/473,710

(22) Filed: Mar. 30, 2017

(51) Int. Cl. F02C 7/20; F01D 25/24; B23P 19/04

(52) U.S. Cl. CPC F02C 7/20; F01D 25/24; F05D 2230/70; F05D 2220/30; F05D 2240/35; B23P 19/042

(57) ABSTRACT

A method for removing a combustor component from an assembled turbine engine is provided. The method includes disposing a truss structure in the vicinity of a turbine engine enclosure. The truss structure is mounted to a support surface in the vicinity of the turbine enclosure. A removing means is provided on the truss structure in order to engage with and attach to the combustor component. The removing means is positioned so that the combustor component is accessible to the removing means and then attached to the combustor component. The combustor component is then removed from the assembled turbine engine.

### BACKGROUND

### 1. Field

The present disclosure relates generally to servicing a turbine engine, and more particularly, to a method for removing a combustor component from an assembled turbine engine.

### 2. Description of the Related Art

A typical combustor inspection requires the turbine engine to be in an outage state. Once the equipment has cooled down, components comprising the combustor section of the turbine such as the top hat, support housing, basket transition and auxiliary piping, for example, typically require a mobile crane to be onsite for their removal from the turbine engine. The mobile crane is positioned adjacent to the turbine enclosure which houses the turbine engine, the roof to the enclosure is opened or removed, the combustor components attached to the crane, and the turbine components are removed using the mobile crane. The combustor components are then transported to an offsite location where an inspection of the components will occur. However, having a mobile crane onsite for the combustor component removal is expensive.

Performing a combustor inspection without a crane to remove the components from the assembled gas turbine has been previously explored. For example, I-beam structures, jib cranes, crane hoists/winches, and using human strength alone to accomplish the component removal have been attempted. Ultimately, though, these tooling options still require use of a mobile crane or other expensive equipment to safely set them up. For example, using an I-beam with a rolling chain hoist may be able to remove the combustion components from the turbine engine, however, the weight of the I-beam would be too heavy for the technicians to safely put in place. Using human strength alone to remove the combustor components is too strenuous, endangering the health of the technicians involved. Consequently, there remains a need for a more inexpensive method to remove the combustor components from an assembled turbine engine than using a mobile crane.

### SUMMARY

Briefly described, aspects of the present disclosure relates to a method for removing a combustor component from an assembled turbine engine and a method for removing a combustor component from an assembled turbine engine without using a mobile crane.

A method for removing a combustor component from an assembled turbine engine is provided. The method includes disposing a truss structure in the vicinity of a turbine engine enclosure. The truss structure is mounted to a support surface in the vicinity of the turbine enclosure. The truss structure includes a removing means configured to remove a turbine engine component. The removing means is positioned so that it is in an accessible positon to engage with and attach to the combustor component. The removing means is attached to the combustor component. The removing means are used to remove the combustor component.

A method for removing a combustor component from an assembled turbine engine is provided. A rapidly deployable stationary structure is arranged in the vicinity of a turbine engine enclosure, the structure adapted to support the load of a combustor component. The combustor component is then removed from the assembled turbine engine without using a mobile crane.

### BRIEF DESCRIPTION OF THE DRAWINGS

FIG. 1 illustrates a standard box truss, and

FIG. 2 illustrates a first embodiment of a box truss assembly,

FIG. 3 illustrates a second embodiment of a box truss assembly,

FIG. 4 illustrates a third embodiment of a box truss assembly,

FIG. 5 illustrates a fourth embodiment of a box truss assembly, and

FIG. 6 illustrates a fifth embodiment of a box truss assembly.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

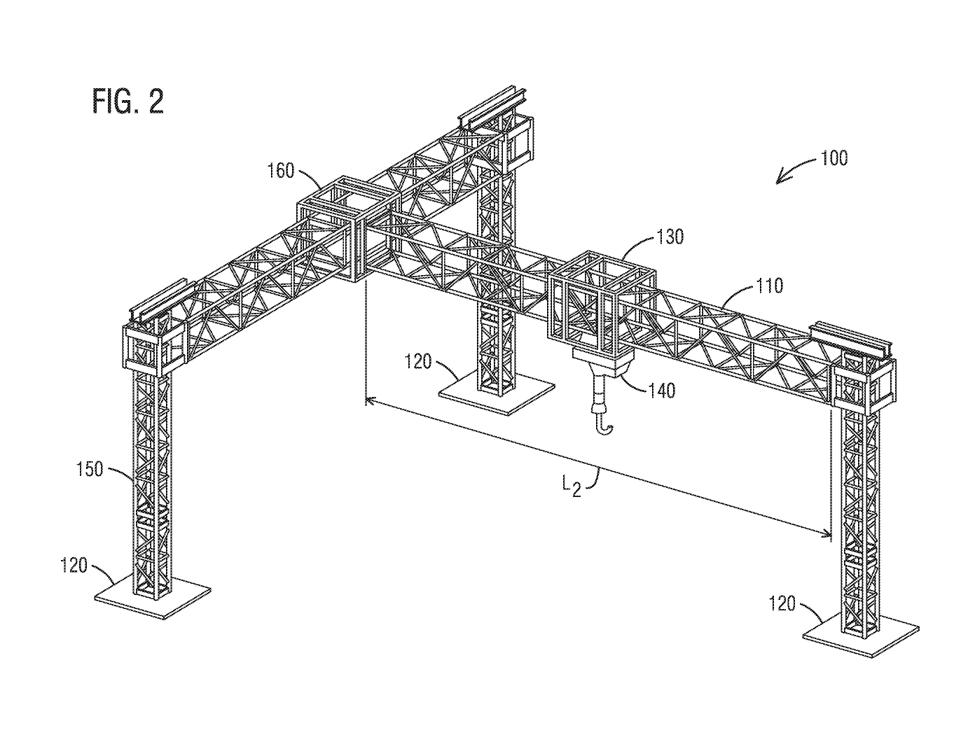

Aluminium box truss assemblies have traditionally been used to provide lighting, sound, special effects, etc. for stage performances and concerts, specifically in the entertainment industry. The aluminium box truss is light weight and structurally sound, enabling it to handle the loads required for a combustion inspection. For example, for the proposed embodiment illustrated in FIG. 2 showing a 3 leg truss structure, the structural bolts connecting the two truss structures which would span the turbine engine can withstand about 180,000 pounds of shear force across the four shanks far exceeding the anticipated load for any of the combustor components to be removed.

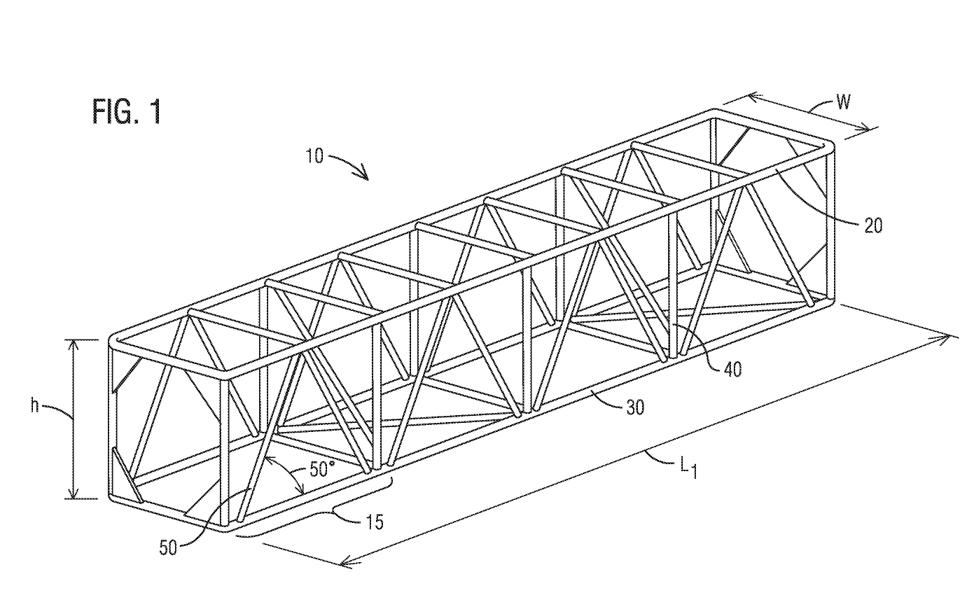

The aluminium box truss may be used as a building block for the truss assembly used in the proposed method to remove a combustor component from an assembled turbine engine. A conventional box truss structure may be seen in FIG. 1. The box truss structure comprises a rectangular truss frame 10 including a plurality of individual box units 15. Each individual unit 15 includes a top rail 20 and a bottom rail 30 common to all the individual box units 15. Vertical rails 40 are positioned along the frame 10 connecting the top and bottom rails 20, 30, each vertical rail 40 abutting the top and bottom rail 20, 30, such that the vertical rail 40 is perpendicular to the top and bottom rails 20, 30. The vertical rails 40 section the truss frame 10 into the individual units 15 such that each unit 15 is essentially a box having a height h, width w, and length L₁. Between the vertical rails 40 on the front and back faces two angled rails 50 extend between the top and bottom rails 20, 30 for each individual unit 15. The two angled rails 50 typically extend at a 50 degree angle with the bottom rail 30 as shown.

A truss structure 100, as seen in the embodiments of FIGS. 2-6, used for the proposed method may include a support portion 150 including a base 120 and a positioning portion 110. The positioning portion 110 may include a removing means 140. An embodiment of a truss structure 100 illustrating a 3 leg truss structure may be seen in FIG. 2. In this embodiment, the support portion 150 is a vertical truss frame having a base 120 which attaches to a support surface. Horizontal truss frames comprise the positioning portion 110 in this embodiment and connect at a connecting point 160. A positioning means 130 is adapted to traverse the length L₂ of horizontal truss frame 110. The positioning means 130 may be a sleeve block as shown in FIG. 2. The positioning means 130 may include a removing means 140 which may be a chain hoist as shown. The chain hoist may be operated manually or remotely if the chain hoist includes a motor.

Referring to FIGS. 1-6, a method for removing a combustor component from an assembled turbine engine is provided. The method includes disposing a truss structure, for example, a truss structure 100 including a rectangular truss frame as illustrated in FIG. 1, in a vicinity of a turbine enclosure. The turbine enclosure is a separate enclosed structure, housing the turbine engine, protecting it from environmental conditions and absorbing some of the noise associated with operating the turbine engine. For purposes of this application, in the vicinity of the turbine enclosure may include within the turbine enclosure, positioned on or adjacent to the turbine enclosure, or surrounding the turbine enclosure.

According to the method, the truss structure 100 is mounted to a support surface the vicinity of the turbine enclosure. The mounting includes positioning the base 120 of the structure 100 on a support surface and securing the base 120 to the support surface. In an embodiment, the support surface may include a ground surface surrounding the turbine enclosure. In another embodiment, the support surface may include a turbine casing. Additionally, in a further embodiment the support surface may include the roof of the turbine enclosure. The base may be free standing or the base may secured to the support surface using fasteners, for instance. How the base is secured to the support surface depends on the load and/or how the truss structure 100 will be used.

In order to remove the component, a positioning means 130 including the removing means 140 may be positioned so that the removing means 140 may engage with and attach to the combustor component. In the embodiment of the 3 leg truss structure shown in FIG. 2, the positioning means 130 is a sleeve block that is configured to traverse the length L₂ of the horizontal truss frame 110 such that it may easily access a combustor component positioned below the chain hoist 140. The chain hoist 140 is then attached to the combustor component. In the case of a chain hoist, a mechanism may lower a hook to attach the component. Once attached, the chain hoist 140 may remove the combustor component from the assembled turbine engine by raising the hook with the attached component. The sleeve block 130 may then be repositioned by traversing the length L₂ of the horizontal truss frame 110 to a removal area. At the removal area, the combustor component may be unattached from the chain hoist.

In an embodiment of the method, the combustor component may be transported to an offsite facility for a combustor inspection after the removing is completed.

The truss structure 100 may be disposed in a variety of configurations which will now be discussed. Different configurations of the truss structure 100 may accommodate the different circumstances of the particular site where the truss structure will be used. For example, different sites may have different piping layouts, different obstructions, a different configuration of catwalks, etc. Additionally, depending on the clearance at the particular site, the technicians may choose a truss structure configuration right for the site and combustor component removal.

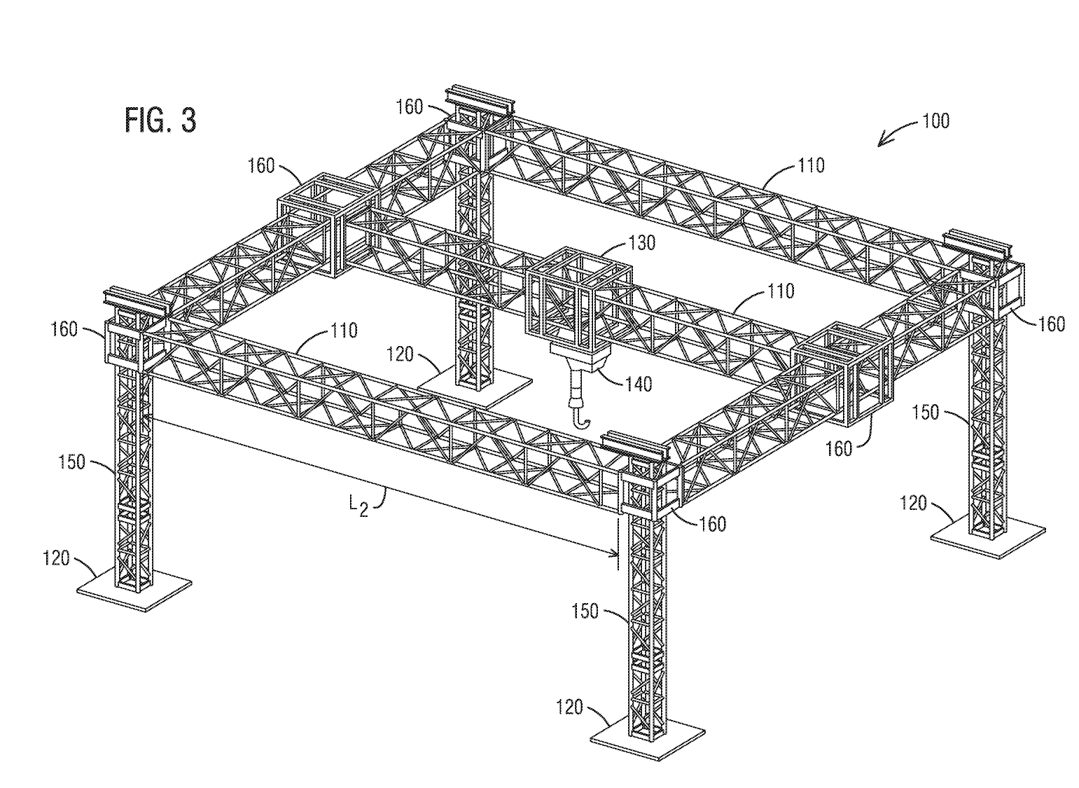

In addition to the 3 leg truss structure embodiment, discussed above, another embodiment may include a four leg gantry truss structure 100. Similarly to the 3 leg structure, the four leg gantry structure, shown in FIG. 3, includes vertical truss frames 150 each having a base 120 which attaches to a support surface. Four horizontal truss frames comprise the positioning portion 110 and connect at corner connecting points 160. Additionally, the positioning portion 110 includes a bridge-like fifth horizontal truss frame extending between two other horizontal truss frames and connects to these horizontal truss frames at connecting points 160. The positioning means 130 traverses along the length L₂ of the fifth horizontal truss frame and may be positioned such that the removing means 140 may engage with and attach to the combustor component.

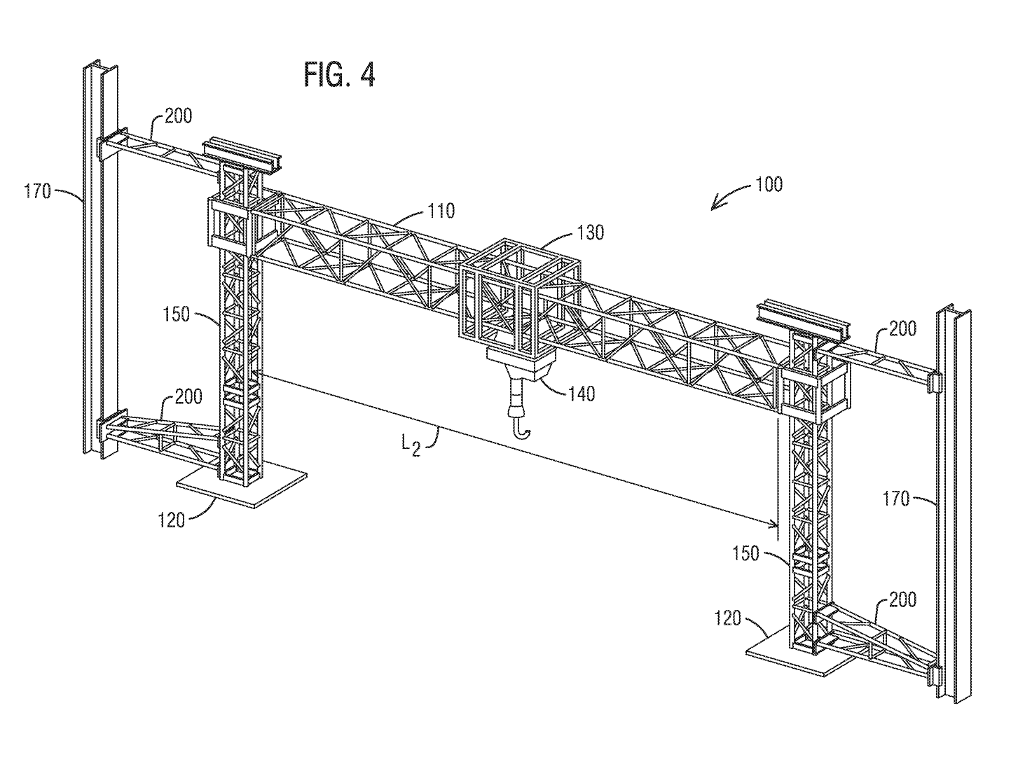

In an embodiment illustrated in FIG. 4, the truss structure 100 may be connected between I-beams 170. The vertical truss frames 150, as shown, are each attached to I-beams 170 using a support bar 200 and fasteners, the fasteners securing the support bars 200 to the I-beam 170 and vertical truss frame 150, respectively. The I-beams 170 may already be disposed and attached to a ground surface in the vicinity of the turbine enclosure or would need a crane to position them in the vicinity of the turbine enclosure. Similarly to the above described embodiments, a horizontal truss frame 110 may include a positioning means 130 which traverses along the length L₂ of the horizontal truss frame 110. By traversing the length of the horizontal truss frame 110, the positioning means 130 may be positioned such that the removing means 140 may engage with and attach to the combustor component.

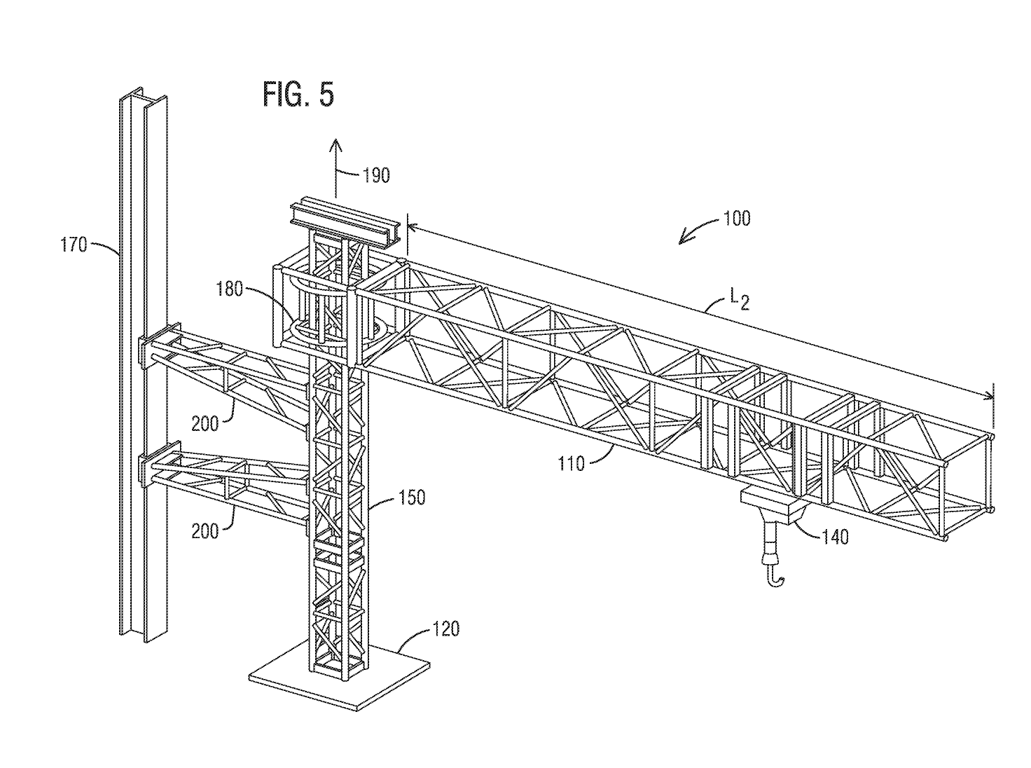

In an embodiment illustrated in FIG. 5, the truss structure 100 may include a rotating portion 180. The horizontal truss frame 110 connects to the vertical truss frame 150 by the rotating portion 180. The rotating portion 180 is adapted to rotate the positioning portion 110 about a longitudinal axis 190 of the support portion 150 so that the removing means 140 is in an accessible position to attach to the combustor component. The removing means 140 may be attached to a sleeve block 130 so that the removing means 140 may traverse the horizontal truss frame 110. This embodiment of the truss structure 100 may be attached by a support bar 200 and fasteners to an I-beam 170 for further support. As discussed above, in connection with the embodiment of FIG. 4, the I-beams 170 may be disposed and attached to a ground surface in the vicinity of the turbine enclosure.

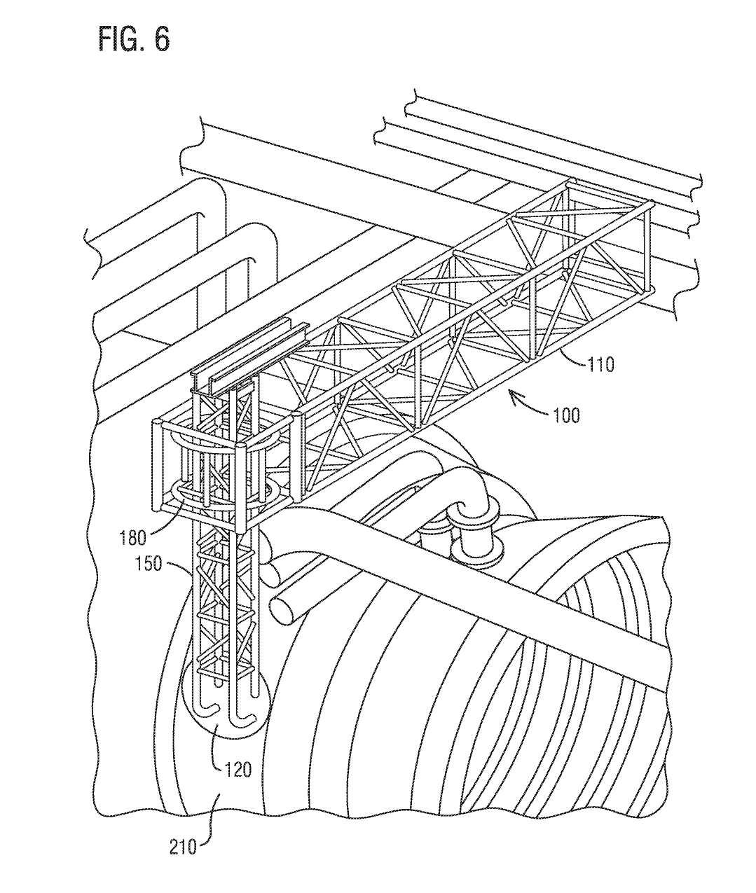

In an embodiment illustrated in FIG. 6, the base 120 of the support portion 110 may attach to a manway of a turbine casing 210. Fasteners may be used to attach the base 120 to the turbine casing 210. Similarly to the embodiment of FIG. 5, a rotating portion 180 is configured to rotate the positioning portion 110 of the truss structure 100 so that the removing means 140 is in an accessible position to engage with and attach to the combustor component. In this example, there may be locations on the truss structure to attach a crane hoist so that the components may be removed manually.

The disclosed method may be reliably and cost-effectively used to remove combustor components from an assembled turbine engine. A truss frame is a structurally sound and light weight structure that can safely carry the load of a combustor component. Furthermore, the truss structure is easily built in the vicinity of the turbine enclosure by technicians. The different truss structure configurations described in the embodiments of FIGS. 2-6 may be used depending on the particular arrangement of the turbine engine, the turbine enclosure, and the particular size and location of the turbine component. The described embodiments would eliminate the requirement of having a crane onsite.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A method for removing a combustor component from an assembled turbine engine, comprising:
disposing a truss structure in a vicinity of a turbine engine enclosure;
mounting the truss structure including a removing means to a support surface in a vicinity of the turbine enclosure;
positioning the removing means so that the removing means is in an accessible position to engage with and attach to the combustor component;
attaching the removing means to the combustor component; and
removing the combustor component from the assembled turbine engine with the removing means.

2. The method as claimed in claim 1, wherein the truss structure includes a truss frame comprising a support portion including a base and a positioning portion including the removing means.

3. The method as claimed in claim 2, wherein the mounting includes positioning the base on the support surface and securing the base to the support surface.

4. The method as claimed in claim 3, wherein the mounting further includes attaching the support portion of the truss frame to an I-beam fixed to the support surface.

5. The method as claimed in claim 1, wherein the support surface is a roof of the turbine enclosure.

6. The method as claimed in claim 1, wherein the support surface is a ground surface surrounding the turbine enclosure.

7. The method as claimed in claim 1, wherein the support surface is a turbine casing.

8. The method as claimed in claim 1, wherein the positioning further comprises traversing a sleeve block attached to the removing means along the length of the positioning portion of the truss frame such that the removing means may engage the combustor component.

9. The method as claimed in claim 8, wherein the removing means is a chain hoist.

10. The method as claimed in claim 4,
wherein the positioning portion is connected to the support portion by a rotating portion,
wherein the rotating portion is adapted to rotate the positioning portion about a longitudinal axis of the support portion,
wherein the positioning includes rotating the positioning portion so that the removing means is in an accessible position to attach to the combustor component.

11. The method as claimed in claim 1, wherein the removing further includes removing the combustor component from the removing means and transporting the combustor component offsite for a combustor inspection.

12. A method for removing a combustor component from an assembled turbine engine without using a mobile crane, comprising:
arranging a rapidly deployable stationary structure in a vicinity of a turbine engine enclosure, the structure adapted to support the load of a combustor component; and
removing the combustor component from the assembled turbine engine without using a mobile crane.

13. The method as claimed in claim 12, wherein the arranging includes mounting a truss structure including a removing means to a support surface in the vicinity of the turbine engine.

14. The method as claimed in claim 20, wherein the support surface is a turbine casing.

15. The method as claimed in claim 21, wherein the truss structure includes a support portion mounted to the turbine casing and a positioning portion configured to pivot about a longitudinal axis of the support portion, and wherein the positioning portion includes the removing means.

16. The method as claimed in claim 22, wherein the removing further includes positioning the removing means such that the removing means engages the combustor component.
